(19) United States
(12) Patent Application Publication
(10) Pub. No.: US 2026/0332941 A1
(43) Pub. Date: Oct. 22, 2026

(54) ACOUSTIC CAVITY DESIGN FOR LOUDSPEAKER ENCLOSURES

(71) Applicant: HARMAN INTERNATIONAL INDUSTRIES, INCORPORATED, Stamford, CT (US)

(72) Inventors: Hongfei ZHOU, Shenzhen, Guangdong (CN); Qiang XIE, Shenzhen, Guangdong (CN); Jiahe LIU, Shenzhen, Guangdong (CN)

(21) Appl. No.: 19/109,735

(22) PCT Filed: Sep. 30, 2022
(86) PCT No.: PCT/CN2022/123112

§ 371 Date: Mar. 7, 2025

(51) Int. Cl. H04R 1/28; H04R 31/00

(52) U.S. Cl. CPC H04R 1/2811; H04R 31/006

(57) ABSTRACT

Various embodiments disclose an enclosure for a speaker comprising a front end configured to mount a speaker cone included in a speaker driver, one or more side walls, wherein the one or more side walls define a cavity surrounding the speaker driver; and a back end, wherein: one or more resonators are attached to a portion of the back end or the one or more side walls, and the one or more resonators and the cavity combine to form an acoustic cavity that encloses a volume of air.

### BACKGROUND

### Field of the Various Embodiments

Embodiments of the present disclosure relate generally to audio reproduction devices and, more specifically, to an acoustic cavity design for loudspeaker enclosures.

### Description of the Related Art

A loudspeaker converts electrical energy, such as an electrical audio signal, into mechanical energy in the form of soundwaves. Loudspeakers are designed to accurately reproduce a large range of audio content and are tested in providing such accuracy by testing the sound pressure levels (SPLs) over a range of frequencies, where the SPL indicates how much the loudspeaker produces sound at a given frequency. The accuracy of the frequency response of the loudspeaker indicates how accurately the produced sound matches the audio signal at a given frequency (e.g., whether the loudspeaker matches the pitch of the audio signal).

When designing a loudspeaker, various characteristics of the speaker may lead to distortions at certain frequencies or over a frequency range. For example, loudspeakers are designed to have a speaker enclosure enclosing a volume and a speaker driver that includes a magnet system that responds to a magnetic field generated by a voice coil. In some cases, the magnet system is physically configured within the speaker enclosure such that portions of the magnet system and the frame of the speaker enclosure form an acoustic volume within the loudspeaker. Depending upon the configuration, the speaker enclosure includes multiple acoustic volumes, which can interact to create undesired fluctuations in output soundwaves within certain frequency ranges.

Conventional techniques to compensate for such discontinuities include adding physical dampers to portions of the speaker enclosure. However, such techniques involve the manual installation of additional expensive materials, increasing the costs of the loudspeaker. Further, the additional physical dampers change the impedance of the loudspeaker, causing energy loss when driven by conventional amplifiers and increasing the probability that the loudspeaker will fail, which decreases the robustness of the loudspeaker. Other techniques involve fabricating loudspeakers that include smaller magnet systems. However, such devices are more expensive and produce lower sound pressure levels.

In light of the above, more effective loudspeakers are needed to produce consistent sound pressure levels over a wide frequency range.

### SUMMARY

Various embodiments disclose an enclosure for a speaker comprising a front end configured to mount a speaker cone included in a speaker driver, one or more side walls, wherein the one or more side walls define a cavity surrounding the speaker driver; and a back end, wherein: one or more resonators are attached to a portion of the back end or the one or more side walls, and the one or more resonators and the cavity combine to form an acoustic cavity that encloses a volume of air.

Further embodiments provide, among other things, a speaker system and a method for manufacturing the electronic device set forth above.

At least one technical advantage of the disclosed embodiments relative to prior art is that, with the disclosed techniques, a speaker device has a frequency response with less pronounced fluctuations than prior art speaker devices that do not use the disclosed techniques. The disclosed techniques allow the speaker device to reproduce higher quality sound. Another advantage is that the speaker device using the disclosed techniques provides the improved frequency response without the addition of expensive damping materials, which change the impedance of the speaker device and increase the cost of the speaker device. These techniques provide one or more technological advantages over prior art techniques.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a diagram illustrating a loudspeaker device;

FIG. 2 is a schematic diagram of an electronic circuit for modeling the frequency response of the loudspeaker device of FIG. 1;

FIG. 3A is a graph of an impedance of the electronic circuit of FIG. 2, according to various embodiments;

FIG. 3B is a graph of the frequency response of the loudspeaker device of FIG. 1, according to various embodiments;

FIG. 4 is a diagram illustrating a loudspeaker device including a group of additional resonators, according to various embodiments;

FIG. 5 is a schematic diagram of an electronic circuit for modeling the loudspeaker device of FIG. 4, according to various embodiments;

FIG. 6A is a graph comparing the electrical impedance of the electronic circuit of FIG. 5 relative to the impedance of the electronic circuit of FIG. 2, according to various embodiments;

FIG. 6B is a graph comparing measurements of the actual frequency responses of the loudspeaker device of FIG. 4 relative to a loudspeaker device without the resonator array, according to various embodiments;

FIG. 7 is a frequency response of a model of the resonator array of FIG. 4, according to various embodiments;

FIG. 8 is a diagram illustrating a resonator array for use in a loudspeaker device, according to various embodiments;

FIG. 9 is a diagram illustrating another loudspeaker device include a resonator array, according to various embodiments; and

FIG. 10 illustrates a flow diagram of method steps of designing and producing a loudspeaker device including one or more resonators; according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

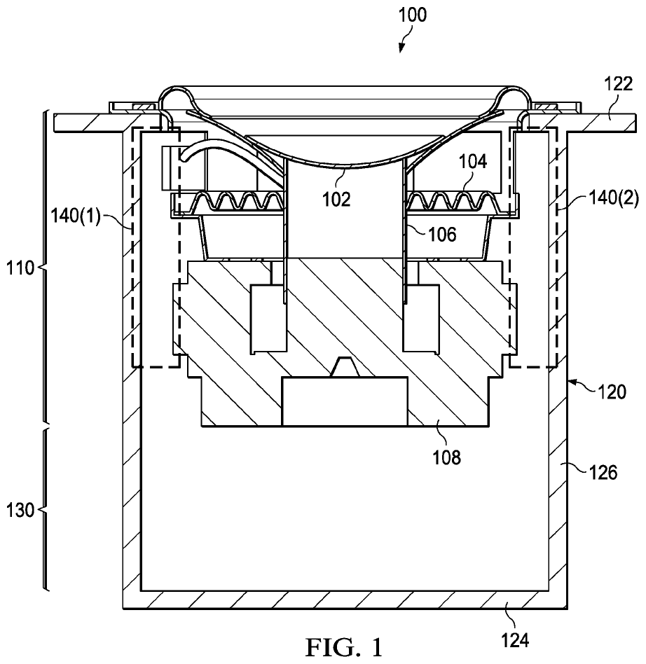

FIG. 1 is a diagram illustrating a loudspeaker device 100. As shown, the loudspeaker device 100 includes a speaker driver 110, a frame 120, an acoustic volume 130, and acoustic volumes 140 (e.g., 140(1), 140(2)). The frame 120 includes a front end 122, a back end 124, and one or more side walls 126. The speaker driver 110 includes a cone 102, a flexible spider 104, a pole 106, and a magnet system 108.

The loudspeaker device 100 is a speaker enclosure defined by the frame 120 that acts as a housing for the other components. The frame 120 encompasses the speaker driver 110, which is connected to the front end 122, and the acoustic volumes 130, 140, which are defined by the back end 124, the sides of the frame 120, and portions of the speaker driver 110. The loudspeaker device 100 is an energy converter that converts electrical energy into mechanical energy in the form of soundwaves. In operation, the speaker driver 110 produces sound waves in response to an electric current. The speaker driver 110 includes a coil of wire (“voice coil”), which is wrapped around the pole 106 and is attached to a terminal (not shown). The voice coil is suspended between poles of a magnet included in the magnet system 108, where the magnet generates a magnetic field. Applying an electrical audio signal to the voice coil via the terminal causes the voice coil to move within the magnetic field. The cone 102 moves due to the movement of the pole 106, causing air pressure waves to be generated, where the air pressure waves are perceived by users as sound waves.

The characteristics of the acoustic volume 130 affect the sound waves that the loudspeaker device 100 outputs. The size of the acoustic volume 130 affects the resonance of speaker driver 110, where larger enclosures more closely approximate a free air cavity. Other characteristics affect the operation of the loudspeaker device 100. For example, a portion of the frame 120 and the magnet system 108 form acoustic volumes 140(1), 140(2) (e.g., shown as separate sections of a volume that surrounds the magnet system 108) that modifies the output provided by the loudspeaker device 100. As will be discussed in further detail below, the addition of the acoustic volume 140 modifies the acoustic impedance of the loudspeaker device and alters the output of the loudspeaker device 100 over various frequency ranges.

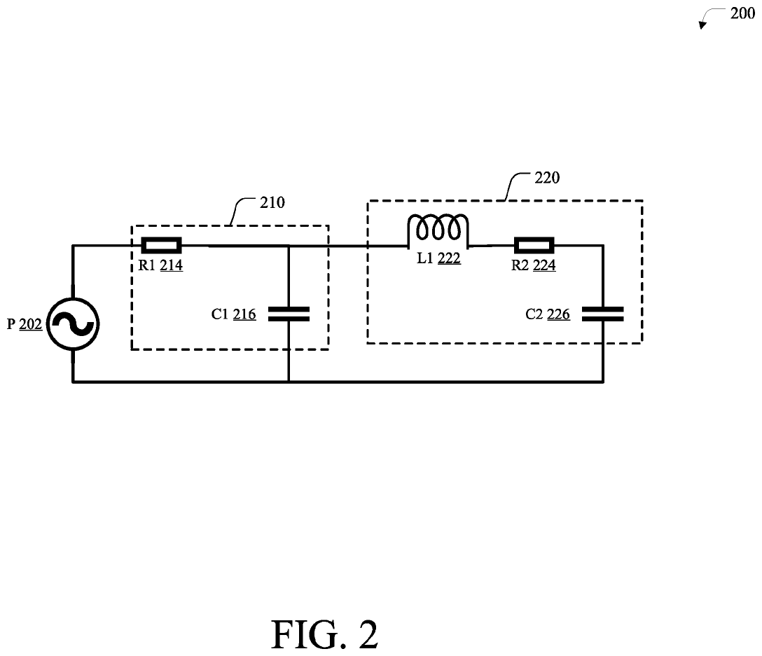

FIG. 2 is a schematic diagram of an electronic circuit 200 for modeling the frequency response of the loudspeaker device 100 of FIG. 1. The electronic circuit 200 includes a power source 202, a first loop 210 and a second loop 220. The first loop 210 includes a first resistor 214 and a first capacitor 216. The second loop 220 includes an inductor 222, a second resistor 224, and a second capacitor 226.

When the loudspeaker device 100 compresses air to produce sound, the air has characteristics, such as acoustic compliance and acoustic inertance, that affect how the air moves within the acoustic volume 130. The ratio of acoustic pressure to flow is represented by an acoustic impedance. The acoustic compliances, inertances, and impedances can be represented in an equivalent RLC circuit. The electronic circuit 200 provides an equivalent model of the physical interactions of the acoustic properties as a combination of series and parallel electrical elements. In such instances, the electronic circuit 200 can be solved using loop and nodal analysis.

Conventional techniques of speaker design generally represent the loudspeaker device 100 using only the first loop 210, where the acoustic volume 130 is represented as having an acoustic resistance, represented by the first resistor 214, and an acoustic capacitance, represented by the first capacitor 216. However, due to the additional acoustic volumes 140 and the acoustic mass formed by the magnetic system 108 and the sidewall 126 between the acoustic volumes 140 and 130 (not shown) in the loudspeaker device 100, the first loop 210 alone does not accurately represent the acoustic characteristics of the loudspeaker device 100. Instead, the electronic circuit 200 includes a second loop 220 to represent the additional acoustic volume 130 and the acoustic mass, where the second loop 220 includes an additional acoustic resistance (represented by the second resistor 224), an additional acoustic capacitance (represented by the second capacitor 226), and an acoustic mass (represented by the inductor 222).

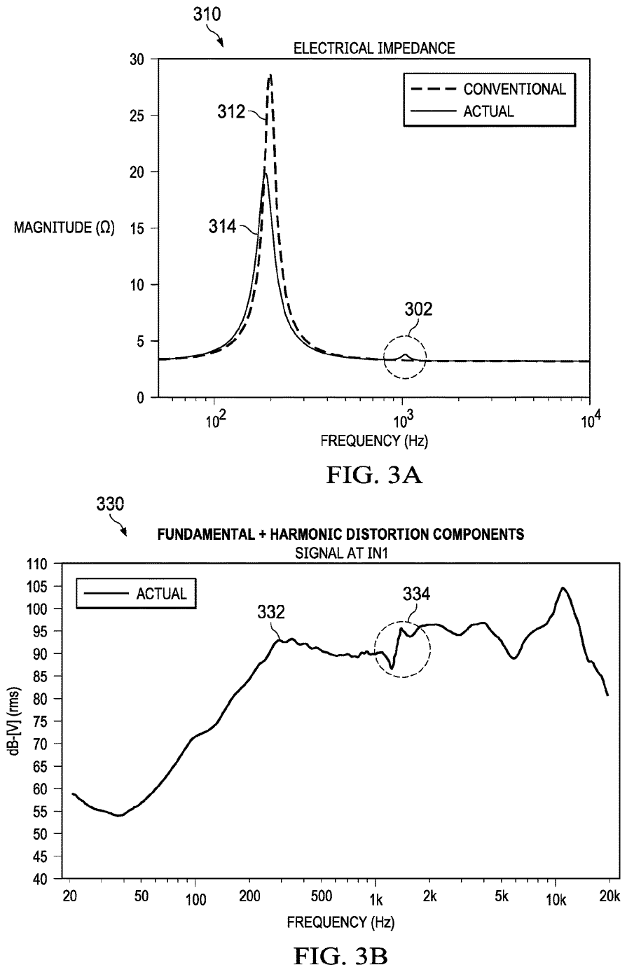

The addition of the second loop 220 affects the impedance of the modeled system that were otherwise not considered when designing the loudspeaker device 100. As will be discussed further in FIGS. 3A and 3B, a result of the additional impedance in the electronic circuit 200 relative to that represented by only the first loop 210 is that the loudspeaker device 100 has different characteristics than expected when simulated based on only the first loop 210. Such differences between the expected characteristics and the actual characteristics result in the loudspeaker device 100 generating an inaccurate reproduction of audio signals at certain frequencies.

FIG. 3A is a graph 310 of a model electrical impedance of the electronic circuit of FIG. 2, according to various embodiments. FIG. 3B is a graph 330 of the frequency response of the loudspeaker device of FIG. 1, according to various embodiments. Graph 310 illustrates models of an equivalent electrical impedance 312 based on the electronic circuit 200 and an electrical impedance 314 of the loudspeaker device 100. Graph 330 illustrates a measurement of the actual frequency response 332 of the loudspeaker device 100.

As discussed above, a conventional electronic equivalent circuit of the loudspeaker device 100 includes only the first loop 210. The electrical impedance 312 of an electrical circuit containing only the first loop 210 is represented in the graph 310 where the impedance modeled is based on the values of the first resistor 214 and the first capacitor 216. In contrast, the electronic circuit 200 includes impedances based on both the first loop 210 and the second loop 220. As shown in the graph 310, the electrical impedance 314 modeling the entire electronic circuit 200 is higher than expected for at least one frequency range 302. Higher impedances at the frequency range 302 results in the loudspeaker device 100 producing distorted sound waves when reproducing electrical audio signals at the frequency range 302.

Graph 330 illustrates measurements of the actual frequency response for the loudspeaker device 100. For loudspeakers, the frequency response 332 is the sound pressure as a function of the reproduced sound frequency, with higher values indicating larger volumes. Due to the additional impedance for the electronic circuit 200 shown in the frequency range 302, the frequency response 332 of the electronic circuit 200 also includes a fluctuation. The fluctuation is a temporary increase (or decrease) in the frequency response of the electronic circuit 200, followed by a separate temporary decrease (or increase) in the frequency response.

Graph 330 illustrates a frequency range 334 over which the loudspeaker device 100 produces a fluctuation in sound pressure. In such instances, the fluctuation in the frequency response 332 causes the loudspeaker device 100 to produce distorted sound waves when reproducing electrical audio signals within the frequency range 334.

### Acoustic Cavity Design for Loudspeaker Enclosures

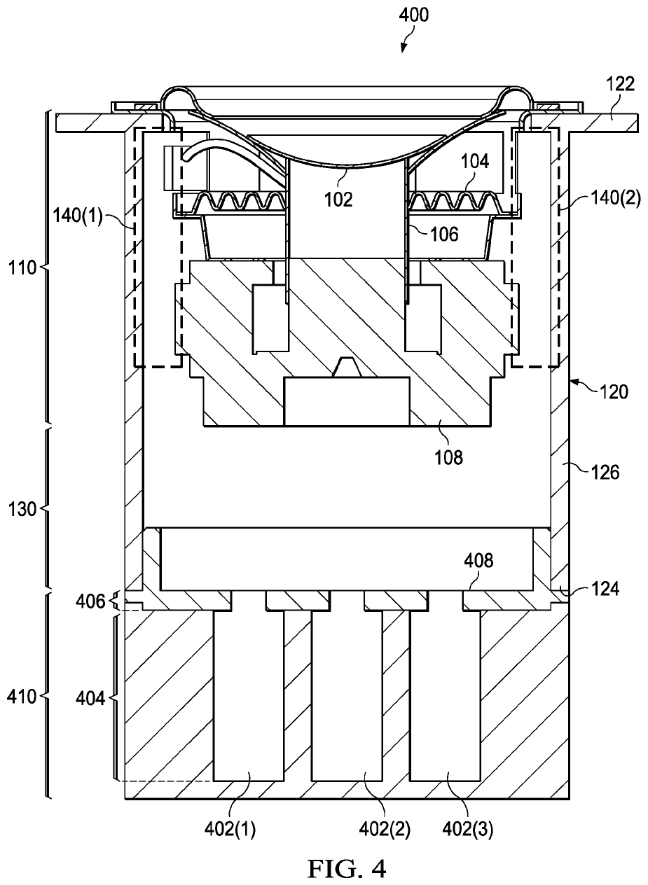

FIG. 4 is a diagram illustrating a loudspeaker device 400 including a group of additional resonators 402, according to various embodiments. As shown, and without limitation, the loudspeaker device 400 includes the speaker driver 110, the acoustic volume 130, the acoustic volume 140, and the resonator array 410. The resonator array 410 includes an interface 408 and a group of resonators 402. Each resonator 402 includes a cavity 404 and a port 406.

The resonator array 410 includes multiple resonators 402 having different characteristics (e.g., the cavity 404 of the resonator 402(1) having a smaller volume than the cavities of resonators 402(2), 402(3)) that act as resonant absorbers. In some embodiments, the resonators 402 act as an acoustic metamaterial (e.g., a subwavelength material with a specific acoustic inductance and capacitance) are formed with sound-absorbing material that absorbs at least a portion of soundwaves produced by the speaker driver 110. The resonator array 410 includes an interface 408 that connects the resonator array 410 to the back end 124 of the frame 120 and acoustic volume 130. The interface 408 includes separate ports 406 for the respective resonators 402. The addition of the resonators 402 in the resonator array 410 causes the acoustic system within the loudspeaker device 400 to change. Each resonator 402 in the resonator array 410 modifies the impedance and frequency response of the loudspeaker device 400 over a limited frequency. In various embodiments, use of multiple resonators 402 alters the output of the loudspeaker device 400 over a larger frequency range or multiple frequency ranges.

In various embodiments, one or more of the resonators 402 in the resonator array 410 have a resonance frequency that is within the frequency range 334 where a fluctuation in the frequency response 332 occurs due to the acoustic volume 140. In operation, the addition of a given resonator 402 compensates for the frequency response 332 over a range of frequencies. Inclusion of multiple resonators 402 in the resonator array 410 provides compensation for a wider frequency range and/or for discontinuous frequency ranges. For example, a first resonator 402(1) compensates for a first fluctuation in a first frequency range (e.g., at 1 kHz) and the second and third resonators 402(2), 402(3) compensate for a second fluctuation of a second frequency range (e.g., around 1.4 kHz).

In various embodiments, one or more resonators 402 in the resonator array 410 are Helmholtz resonators. A given Helmholtz resonator has a resonance frequency that is a function of the cavity 404 and the port 406:

$$f = \frac{{C}_{0}}{2 π} \sqrt{\frac{S}{VL}} \qquad ( Eq . 1 )$$

Where frequency (f) is a function of the speed of sound in a gas (C₀), S corresponds to the sectional area of the port 406, L corresponds to the length of the port 406, and V corresponds to the volume of the cavity 404. In some embodiments, portions of the resonators 402 are the same while other portions differ in order to cause each resonator 402 to have different resonant frequencies. For example, each resonator 402(1), 402(2), 402(3), can share common dimensions for the port 406 and have different volumes for the respective cavities 404.

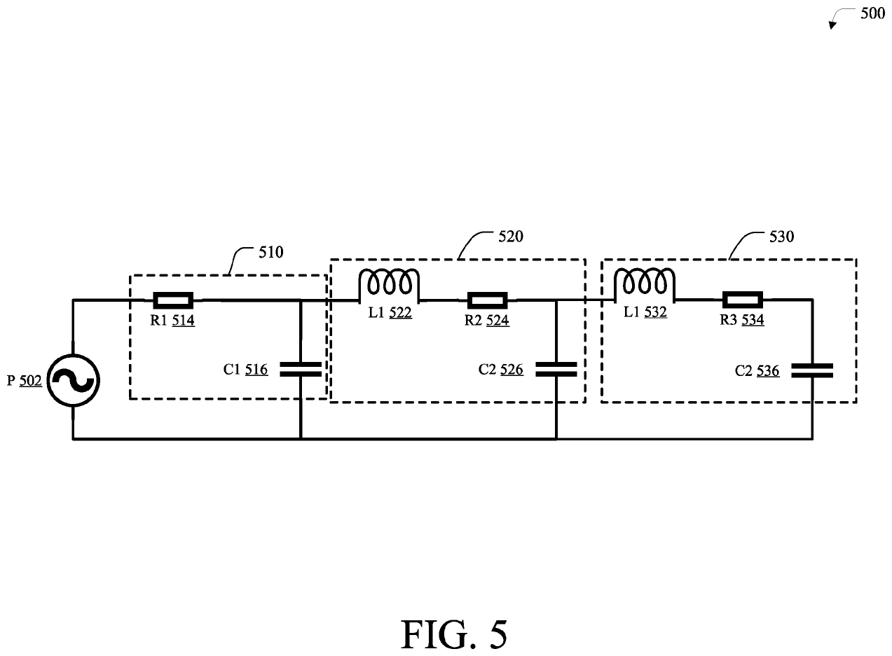

FIG. 5 is a schematic diagram of an electronic circuit 500 corresponding to the loudspeaker device 400 of FIG. 4, according to various embodiments. As shown, and without limitations, the electronic circuit 500 includes a power source 502, a first loop 510, a second loop 520, and a third loop 530. The first loop 510 includes a first resistor 514 and a first capacitor 516. The second loop 520 includes a first inductor 522, a second resistor 524, and a second capacitor 526. The third loop 530 includes a second inductor 532, a third resistor 534, and a third capacitor 536.

The electronic circuit 500 is similar to the electronic circuit 200. The electronic circuit 500 includes the additional third loop 530, where the second inductor 532, the third resistor 534, and the third capacitor 536 represent the lumped combination of the acoustic resistances, acoustic capacitances, and acoustic masses of a resonator 402 included in the resonator array 410. Although not shown in FIG. 5, in various embodiments, the electronic circuit 500 can model the lumped acoustic impedance of additional loops corresponding to additional resonators 402 by adding additional loops similar to the previous loop. For example, one or more additional loops for each resonator 402 can be added to the electronic circuit 500.

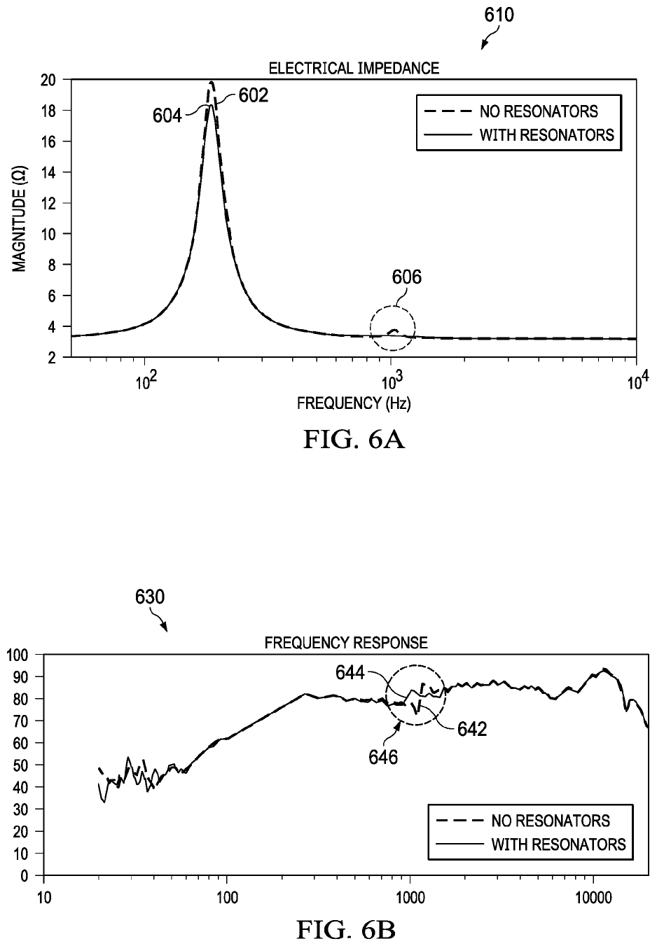

FIG. 6A is a graph 610 comparing the electrical impedance of the electronic circuit 500 of FIG. 5 relative to the electrical impedance of the electronic circuit 200 of FIG. 2, according to various embodiments. FIG. 6B is a graph 630 comparing the frequency responses of the loudspeaker device of FIG. 4 relative to a loudspeaker device without the resonator array 410, according to various embodiments.

As shown, the graph 610 illustrates an equivalent electrical impedance 602 of a loudspeaker device 100 excluding the resonator array 410 and an electrical impedance 604 of the loudspeaker device 400 including the resonator array 410. Graph 330 illustrates measurements of the actual frequency response 642 of the loudspeaker device 100 and the frequency response 644 of the loudspeaker device 400.

As discussed above, the equivalent electronic circuit 500 of the loudspeaker device 400 includes the loops 510-530. Due to the inclusion of a third loop 530 that models the inclusion of a resonator 420, the undesirable change in the impedance of the loudspeaker device 400 in the frequency range 606 is reduced. The inclusion of the third loop 530 in the electronic circuit 500 modeling the loudspeaker device 400 also indicates that the addition of the resonator 402 will also modify the frequency response of the loudspeaker device 400. As shown in graph 630, the loudspeaker device 100 excluding the resonator array 410 produces a frequency response 644 that produces a fluctuation in sound pressure levels (SPLs) in the frequency range 646. In contrast, the loudspeaker device 400 including the resonator array 410 produces a frequency response 642 that is smoother in the same frequency range 646. In such instances, the loudspeaker device 400 reproduces a more accurate representation of the electrical audio signal than the loudspeaker device 100.

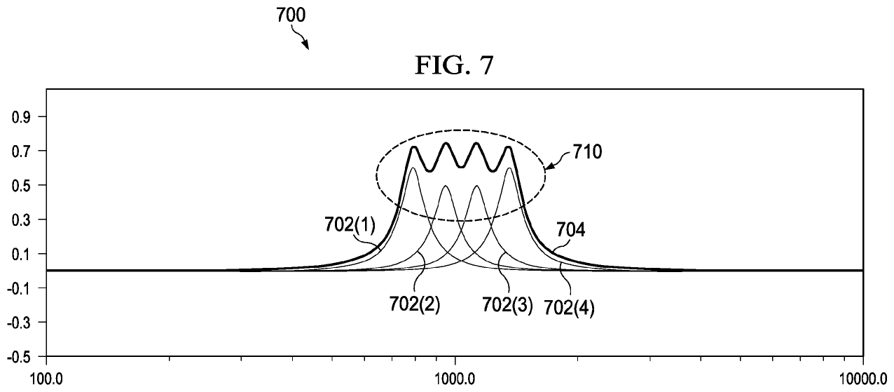

FIG. 7 is a frequency response graph 700 of a model of the resonator array 410 of FIG. 4, according to various embodiments. As shown, the graph 700 includes frequency responses 702 of separate resonators 402, and a composite frequency response 704.

In operation, each of the frequency responses 702(1)-702(4) are combined to produce the composite frequency response 704. In various embodiments, each resonator 402(1)-402(4) corresponding to the respective frequency responses 702(1)-702(4) can be configured to have different resonant frequencies within the frequency range 710. For example, the resonator 402(1) has a resonant frequency of approximately 800 Hz and the resonator 402(4) has a resonant frequency of approximately 1.4 kHz. Each of the resonators 402(1)-402(4) is used to provide compensation for a portion of the frequency range 710 in which a fluctuation in frequency response is detected. When all of the resonators 402(1)-402(4) are included in the loudspeaker, the resonators 402(1)-402(4) collectively provide compensation for fluctuations in the frequency response that occur over the frequency range 710.

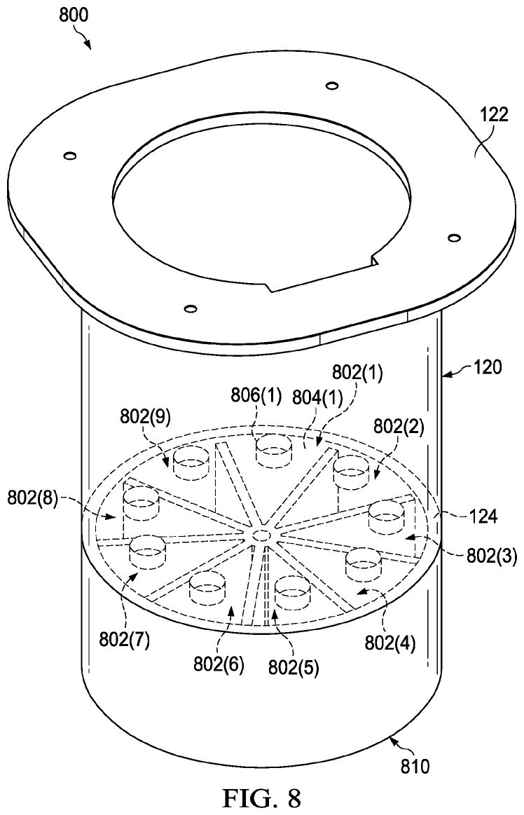

FIG. 8 is a diagram illustrating a resonator array 810 for use with a loudspeaker device, according to various embodiments. As shown, and without limitation, the loudspeaker device 800 includes the frame 120 and the resonator array 810. The frame 120 includes the front end 122 and the back end 124. The resonator array 810 includes resonators 802(1)-802(9), where each resonator 802 has a port 806 and a cavity 804.

In various embodiments, the resonator array 810 is positioned below the back end 124 of the frame 120. In such instances, each port 806 are included in a common interface (not shown) that is connected to the back end 124. Each resonator 802 in the resonator array 810 can have a distinct combination of port 806 size (represented by the transparent cylinder) and/or cavity 804 volume. For example, one or more of the cavities 804 have differing volumes. Additionally or alternatively, one or more of the ports 806 can have different sectional areas. In such instances, each of the different resonators has a different resonant frequency and provides absorption at the resonant frequency.

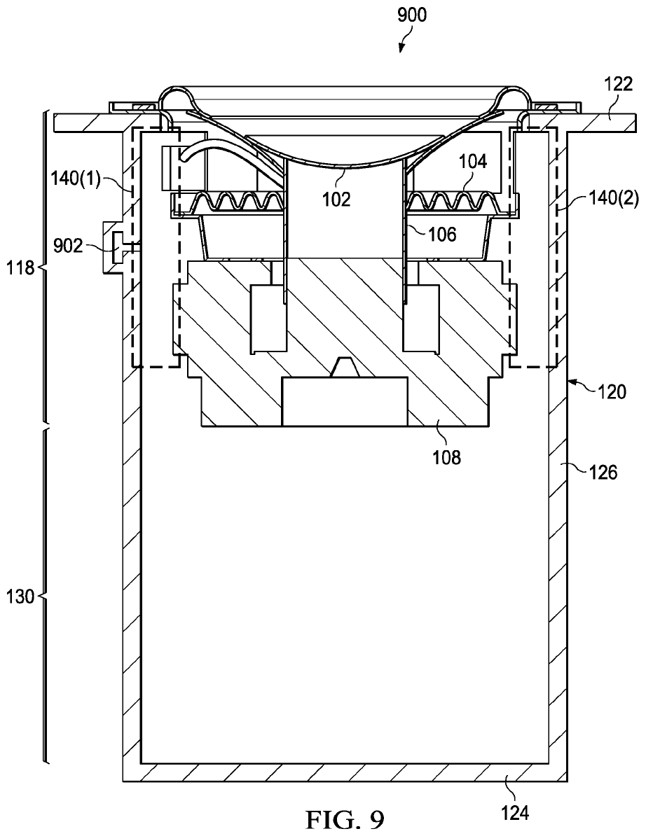

FIG. 9 is a diagram illustrating another loudspeaker device 900 including an additional resonator 902, according to various embodiments. As shown, and without limitation, the loudspeaker device 900 includes the speaker driver 110, the acoustic volume 130, the acoustic volume 140, and a resonator 902. In various embodiments, the loudspeaker device 900 includes the resonator 902 and/or additional resonators (not shown) around the circumference of the frame 120 of the loudspeaker device 900 in lieu of or in addition to the resonator array 410.

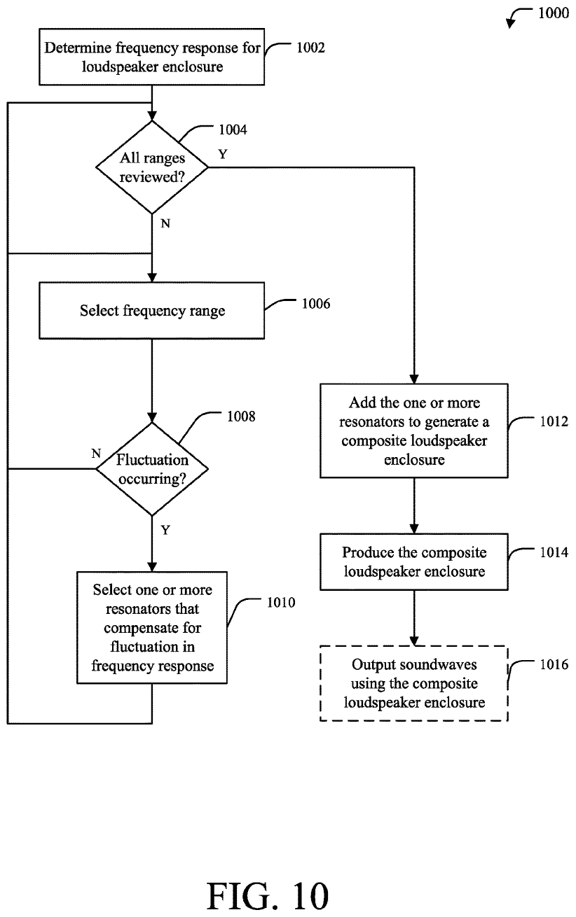

FIG. 10 illustrates a flow diagram of method steps of designing and producing a loudspeaker device including one or more resonators; according to various embodiments. Although the method steps are described with reference to the systems and embodiments of FIGS. 4-9, persons skilled in the art will understand that any system configured to implement the method steps, in any order, falls within the scope of the present disclosure.

As shown, the method 1000 begins at step 1002 where a frequency response is determined for a loudspeaker enclosure. In various embodiments, the frequency response of a loudspeaker device 100 is obtained. In some embodiments, a designer and/or design hardware test the frequency output of a loudspeaker device 100 having a speaker driver 110 and an acoustic volume 130. In some embodiments, the designer provides a test signal that includes a frequency sweep of a desired range (e.g., between 20 Hz and 20 kHz). A microphone receives the soundwaves produced by the loudspeaker device 100 and records the sound pressure level for each frequency.

At step 1004, the frequency response is checked to determine whether each frequency range was reviewed. For example, the frequency response can be separated into distinct logarithmic frequency ranges (e.g., 500 Hz-1 kHz, 1 kHz-2 kIn such instances, each frequency range can be reviewed to determine whether there is a fluctuation in the frequency response of the loudspeaker device 100. When at least one frequency range remains to be reviewed, the designer and/or design hardware proceeds to step 1006; otherwise, the designer and/or design hardware proceeds to step 1012.

At step 1006, a specific frequency range within the frequency response is selected. At step 1008, the designer and/or design hardware determines whether a fluctuation in the frequency response is occurring within the specific frequency range. In various embodiments, a given frequency range is reviewed to determine whether the sound pressure level of the loudspeaker device 100 includes a fluctuation when reproducing the electrical audio signal for frequencies within the given range. For example, the designer can generate a model of the loudspeaker device 100 and can review characteristics of the model, including an expected electrical impedance (e.g., electrical impedance 312 and/or 602) and/or an expected sound pressure level response. Additionally or alternatively, the designer can generate a loudspeaker device and measure the actual frequency response of the loudspeaker device (e.g., frequency responses 332 and/or 642). The fluctuation can include an irregular change (rising or falling) of the sound pressure level relative to the sound pressure levels that were output in neighboring frequency ranges. In some embodiments, the measured sound pressure level can be compared to minimum and/or maximum thresholds for the specific frequency range. Additionally or alternatively, in some embodiments, a derivative of the sound pressure level for the frequency range can be compared to a derivative threshold for the frequency range. When a fluctuation is detected, the designer and/or design hardware proceeds to step 1010. Otherwise, a fluctuation is not detected and the designer and/or design hardware returns to step 1004.

At step 1010, one or more resonators are selected that compensate for the fluctuation in the frequency response. In various embodiments, one or more resonators 402 are selected to compensate for a fluctuation that occurs at a specific frequency. For example, a resonant absorber having a resonant frequency within the frequency range can be selected. In some embodiments, multiple resonators 402 can be selected to cover a wider frequency range. For example, a pair of resonators can be selected to cover a specific frequency range. Additionally or alternatively, a set of multiple resonators 402, each with resonant frequencies within the selected frequency range, can be selected. In some embodiments, the characteristics of a resonator can be altered based on the selected frequency range. For example, the dimensions of the cavity of the resonator and/or the port can be altered to modify the resonant frequency to occur within the selected frequency range. Upon selecting the one or more resonators for the selected frequency range, method 1000 returns to step 1004 to determine whether another frequency range needs to be reviewed. When it is determined that no other frequency range needs to be reviewed, the method 1000 proceeds to step 1012. Otherwise, it is determined that at least one frequency range needs to be reviewed and the method 1000 returns to step 1004.

At step 1012, the one or more resonators are added to generate a composite loudspeaker enclosure. In various embodiments, a resonator array 410, including the one or more resonators, is added to the loudspeaker enclosure. In some embodiments, the resonator array 410 includes an interface 408 that connects the respective resonators 402 to the acoustic volume 130. Additionally or alternatively, one or more resonators 902 can be added to the frame 120 of the loudspeaker device 100 between the cone 102 and the magnet system 108. Adding the resonator array 410 and/or the resonators 902 generate a composite loudspeaker enclosure.

At step 1014, the composite loudspeaker enclosure is fabricated. In various embodiments, one or more fabrication devices generate the loudspeaker device 400 that includes the composite loudspeaker enclosure. In some embodiments, the fabrication devices form a frame 120 that includes the acoustic volume 130, the resonator array 410, and/or the top resonators 908 as portions of the frame 120. Alternatively, in some embodiments, the fabrication devices form the frame 120 and the resonator array 410 separately. In such instances, the fabrication devices assemble the loudspeaker device 400 by combining the speaker driver 110, the frame 120, and the resonator array 410.

At step 1016, the composite loudspeaker optionally outputs soundwaves based on an input electrical audio signal. In various embodiments, upon fabrication, the loudspeaker device including the resonator array receives an electrical audio signal. For example, the voice coil included in the speaker driver 110 receives the electrical audio signal via a terminal. Applying the electrical audio signal to the voice coil causes the voice coil to move within the magnetic field generated by the magnet system 108. The cone 102 based on the voice coil, causing air within the composite loudspeaker enclosure to alternatively compress and expand. The changes in air pressure create pressure waves, where the air pressure waves are perceived by users as sound waves.

In sum, embodiments of the present disclosure include a speaker enclosure including a main housing and a connected resonator array that combine to enclose a common volume of air. The configuration of the main housing and the speaker driver forms separate acoustic volumes. This includes an acoustic volume below the speaker driver and an additional acoustic volume between a portion of the magnet system and a side of the housing. Each resonator in the resonator array has a resonant frequency within a frequency range where an undesirable fluctuation in sound pressure levels occur. When reproducing an electric audio signal, the composite speaker volume generates a composite frequency response, where fluctuations in the sound pressure level are attenuated by the resonators included in the resonator array.

At least one technical advantage of the disclosed embodiments relative to prior art is that, with the disclosed techniques, a speaker device has a frequency response with less pronounced fluctuations than prior art speaker devices that do not use the disclosed techniques. The disclosed techniques allow the speaker device to reproduce higher quality sound. Another advantage is that the speaker device using the disclosed techniques provides the improved frequency response without the addition of expensive damping materials, which change the impedance of the speaker device and increase the cost of the speaker device. These techniques provide one or more technological advantages over prior art techniques.
1. In various embodiments, an enclosure for a speaker comprises a front end configured to mount a speaker cone coupled to a speaker driver, one or more side walls, where the one or more side walls define a cavity surrounding the speaker driver, and a back end, where one or more resonators are attached to a portion of the back end or the one or more side walls, and the one or more resonators and the cavity combine to form an acoustic cavity that encloses a volume of air.
2. The enclosure of clause 1, where a first resonator of the one or more resonators has a first resonance frequency within a first frequency range, a second resonator of the one or more resonators has a second resonance frequency within the first frequency range, and the first resonance frequency differs from the second resonance frequency.
3. The enclosure of clause 1, where the one or more resonators reduce a fluctuation in a frequency response of the speaker.
4. The enclosure of any of clauses 1-3, where the fluctuation occurs within a first frequency range, and a first resonator of the one or more resonators has a first resonance frequency within a second frequency range, and the second frequency range falls within the first frequency range.
5. The enclosure of any of clauses 1-4, where the one or more resonators includes at least one Helmholtz resonator.
6. The enclosure of any of clauses 1-5, where the one or more resonators include a first Helmholtz resonator including a first cavity having a first volume, and a first port having a first sectional area and a first length, and a second Helmholtz resonator including a second cavity having a second volume, and a second port having the first sectional area and the first length.
7. The enclosure of any of clauses 1-6, where the one or more resonators include a first Helmholtz resonator including a first cavity having a first volume and a first port having a first sectional area and a first length, and a second Helmholtz resonator including a second cavity having the first volume and a second port having a second sectional area and a second length.
8. The enclosure of any of clauses 1-7, where the one or more resonators form an acoustic metamaterial capable of absorbing soundwaves.
9. In various embodiments, a speaker comprises a speaker driver including a cone, a pole, and a magnet system, a housing, where the speaker driver and the housing define a cavity surrounding the speaker driver, and one or more resonators, coupled to a portion of the housing, where the one or more resonators and the cavity combine to form an acoustic cavity that encloses a volume of air.
10. The speaker of clause 9, where a first resonator of the one or more resonators has a first resonance frequency within a first frequency range, a second resonator of the one or more resonators has a second resonance frequency within the first frequency range, and the first resonance frequency differs from the second resonance frequency.
11. The speaker of clause 9 or 10, where the one or more resonators reduce a fluctuation in a frequency response of the speaker.
12. The speaker of any of clauses 9-11, where the fluctuation occurs within a first frequency range, and a first resonator of the one or more resonators has a first resonance frequency within a second frequency range, and the second frequency range falls within the first frequency range.
13. The speaker of any of clauses 9-12, where the one or more resonators are included in a separate housing, and the separate housing includes an interface connecting the separate housing to a back end of the housing.
14. The speaker of claim 9, where the magnet system and one or more side walls of the housing define an acoustic volume included in the cavity, and a first resonator of the one or more resonators is positioned on the one or more side walls along the acoustic volume.
15. In various embodiments, a method comprises fabricating a housing for a loudspeaker device, the housing including a front end, one or more side walls, and a back end, adding a speaker driver to the housing, wherein the speaker driver and housing define a cavity surrounding the speaker driver, and coupling one or more resonators to the back end or the one or more side walls of the housing, wherein the one or more resonators and the cavity combine to form an acoustic cavity that encloses a volume of air.
16. The method of clause 15, where the one or more resonators are coupled to the back end or the one or more side walls of the housing before fabricating the housing.
17. The method of clause 15 or 16, where the one or more resonators include a plurality of resonators, a first resonator of the plurality of resonators is coupled to the back end of the housing, and a second resonator of the plurality of resonators is coupled to the one or more side walls of the housing.
18. The method of any of clauses 15-17, where the one or more resonators includes at least one Helmholtz resonator.
19. The method of any of clauses 15-18, further comprising upon fabricating the housing, fabricating one or more ports along at least one wall of the housing or along the back end of the housing, where coupling the one or more resonators to the back end or the one or more side walls of the housing comprises connecting each of the one or more resonators to a respective one of the one or more ports.
20. The method of any of clauses 15-19, forming, from the one or more resonators, an acoustic metamaterial capable of absorbing soundwaves.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

1. An enclosure for a speaker comprising:
a front end configured to mount a speaker cone coupled to a speaker driver;
one or more side walls, wherein the one or more side walls define a cavity surrounding the speaker driver; and
a back end, wherein:
one or more resonators are attached to a portion of the back end or the one or more side walls, and
the one or more resonators and the cavity combine to form an acoustic cavity that encloses a volume of air.

2. The enclosure of claim 1, wherein:
a first resonator of the one or more resonators has a first resonance frequency within a first frequency range;
a second resonator of the one or more resonators has a second resonance frequency within the first frequency range; and
the first resonance frequency differs from the second resonance frequency.

3. The enclosure of claim 1, wherein the one or more resonators reduce a fluctuation in a frequency response of the speaker.

4. The enclosure of claim 3, wherein:
the fluctuation occurs within a first frequency range; and
a first resonator of the one or more resonators has a first resonance frequency within a second frequency range; and
the second frequency range falls within the first frequency range.

5. The enclosure of claim 1, wherein the one or more resonators includes at least one Helmholtz resonator.

6. The enclosure of claim 1, wherein the one or more resonators include:
a first Helmholtz resonator including a first cavity having a first volume, and a first port having a first sectional area and a first length; and
a second Helmholtz resonator including a second cavity having a second volume, and a second port having the first sectional area and the first length.

7. The enclosure of claim 1, wherein the one or more resonators include:
a first Helmholtz resonator including a first cavity having a first volume and a first port having a first sectional area and a first length; and
a second Helmholtz resonator including a second cavity having the first volume and a second port having a second sectional area and a second length.

8. The enclosure of claim 1, wherein the one or more resonators form an acoustic metamaterial capable of absorbing soundwaves.

9. A speaker comprising:
a speaker driver including a cone, a pole, and a magnet system;
a housing, wherein the speaker driver and the housing define a cavity surrounding the speaker driver; and
one or more resonators, coupled to a portion of the housing,
wherein the one or more resonators and the cavity combine to form an acoustic cavity that encloses a volume of air.

10. The speaker of claim 9, wherein:
a first resonator of the one or more resonators has a first resonance frequency within a first frequency range;
a second resonator of the one or more resonators has a second resonance frequency within the first frequency range; and
the first resonance frequency differs from the second resonance frequency.

11. The speaker of claim 9, wherein the one or more resonators reduce a fluctuation in a frequency response of the speaker.

12. The speaker of claim 11, wherein:
the fluctuation occurs within a first frequency range; and
a first resonator of the one or more resonators has a first resonance frequency within a second frequency range; and
the second frequency range falls within the first frequency range.

13. The speaker of claim 9, wherein:
the one or more resonators are included in a separate housing; and
the separate housing includes an interface connecting the separate housing to a back end of the housing.

14. The speaker of claim 9, wherein:
the magnet system and one or more side walls of the housing define an acoustic volume included in the cavity; and
a first resonator of the one or more resonators is positioned on the one or more side walls along the acoustic volume.

15. A method comprising:
fabricating a housing for a loudspeaker device, the housing including a front end, one or more side walls, and a back end;
adding a speaker driver to the housing, wherein the speaker driver and housing define a cavity surrounding the speaker driver; and
coupling one or more resonators to the back end or the one or more side walls of the housing, wherein the one or more resonators and the cavity combine to form an acoustic cavity that encloses a volume of air.

16. The method of claim 15, wherein the one or more resonators are coupled to the back end or the one or more side walls of the housing before fabricating the housing.

17. The method of claim 15, wherein:
the one or more resonators include a plurality of resonators;
a first resonator of the plurality of resonators is coupled to the back end of the housing; and
a second resonator of the plurality of resonators is coupled to the one or more side walls of the housing.

18. The method of claim 15, wherein the one or more resonators includes at least one Helmholtz resonator.

19. The method of claim 15, further comprising:
upon fabricating the housing, fabricating one or more ports along at least one wall of the housing or along the back end of the housing,
wherein coupling the one or more resonators to the back end or the one or more side walls of the housing comprises connecting each of the one or more resonators to a respective one of the one or more ports.

20. The method of claim 15, forming, from the one or more resonators, an acoustic metamaterial capable of absorbing soundwaves.
